(19) United States
(12) Patent Application Publication
(10) Pub. No.: US 2026/0161717 A1
(43) Pub. Date: Jun. 11, 2026

(54) IDENTIFICATION OF USER INTENTION FOR AMBIGUOUS SEARCH KEYWORDS

(71) Applicant: Uma Umesh Gajendragadkar, Renton, WA (US)

(72) Inventor: Uma Umesh Gajendragadkar, Renton, WA (US)

(21) Appl. No.: 18/972,381

(22) Filed: Dec. 6, 2024

(51) Int. Cl. G06F 16/9535; G06F 16/2457

(52) U.S. Cl. CPC G06F 16/9535; G06F 16/24578

(57) ABSTRACT

Systems and methods provide personalized search query disambiguation by identifying user intentions for ambiguous search terms using user profiles. In one embodiment, the system receives a query prefix and accesses a user profile containing parameters such as profession, interests, gender, and location. The system applies a Funnel Mesh 5 algorithm, which uses association rule mining to map user profile parameters to possible user intentions. Based on the assigned weights, a subset of profile parameters is selected to filter potential interpretations of the query. The system analyzes past search data, user profiles, and intention matrices to select the most probable user intention. The identified intention is used to expand the query prefix into a complete search string, which is then processed by the search engine to generate contextually relevant results.

### TECHNICAL FIELD

Implementations relate generally to search engine query optimization. More specifically, implementations relate to methods and systems for identifying user intention and disambiguating ambiguous search keywords using personalized user profiles and weighted algorithms.

### BACKGROUND

Search engines have become an integral tool for retrieving information from vast data sources, but identifying relevant results remains a challenge, especially when users input ambiguous or incomplete search queries. Ambiguity in search keywords can arise from polysemy, where a word has multiple meanings (e.g., “Java” could refer to coffee, a programming language, or an island), or from vague queries that lack sufficient context to infer user intent. Traditional search engines rely heavily on matching keywords to indexed documents but struggle to capture the true intention behind a query when the input is unclear or ambiguous. This often forces users to manually refine their queries through trial and error, which is time-consuming and inefficient.

To address these issues, several approaches have been developed to enhance search accuracy. One common approach involves the use of search logs or clickstream data, where a user's past searches and interactions with search results are used to infer their intent. While this method helps personalize search results for frequent users, it is limited by its reliance on historical data and often fails to handle ambiguous or first-time search queries effectively. Other methods, such as query expansion techniques, attempt to automatically broaden a user's query by adding related terms from external sources like thesauri or wordnets. However, these approaches typically lack personalization, applying a one-size-fits-all solution that doesn't take into account the specific context or preferences of individual users.

Consequently, there is a need in the art for a system and method that can dynamically disambiguate search queries by identifying user intention based on personalized user profiles, without solely relying on past search logs or general query expansion techniques.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating ambiguous keywords having multiple contextual interpretations, in accordance with some embodiments.

FIG. 4 is a diagram illustrating an intention matrix, in accordance with some embodiments.

FIG. 5 is a diagram illustrating example data which may be utilized for user intention identification, in accordance with some embodiments.

FIG. 6 is a diagram illustrating the user intention identification process and query autocompletion, in accordance with some embodiments.

FIG. 7 is a diagram illustrating a personalization funnel used to identify user intent, in accordance with some embodiments.

FIG. 8 is a diagram illustrating an FM5 user intention identification algorithm, in accordance with some embodiments.

FIG. 9 is a diagram illustrating user intention categories and examples, in accordance with some embodiments.

FIG. 10 is a diagram illustrating user intention identification, in accordance with some embodiments.

FIG. 11 is a table illustrating example test cases processed by the FM5 algorithm, in accordance with some embodiments.

FIG. 12 is an illustration of a user intention survey, in accordance with some embodiments.

FIG. 13 is a diagram illustrating an exemplary computer that may perform processing in some embodiments.

### DETAILED DESCRIPTION

In this specification, reference is made in detail to specific embodiments of the disclosure.

For clarity in explanation, the disclosure has been provided with reference to specific embodiments, however it should be understood that the disclosure is not limited to the described embodiments. On the contrary, the disclosure covers alternatives, modifications, and equivalents as may be included within its scope as defined by any patent claims. The following embodiments of the disclosure are set forth without any loss of generality to, and without imposing limitations on, the disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In one embodiment, the system receives a query prefix and accesses a user profile containing parameters such as profession, interests, gender, and location. The system applies a Funnel Mesh 5 algorithm, which uses association rule mining to map user profile parameters to possible user intentions. Based on the assigned weights, a subset of profile parameters is selected to filter potential interpretations of the query. The system analyzes past search data, user profiles, and intention matrices to select the most probable user intention. The identified intention is used to expand the query prefix into a complete search string, which is then processed by the search engine to generate contextually relevant results. In some embodiments, the system continually improves its accuracy through machine learning by logging user interactions and outcomes.

Further areas of applicability of the present disclosure will become apparent from the remainder of the detailed description and the claims. The detailed description and specific examples are intended for illustration only and are not intended to limit the scope of the disclosure.

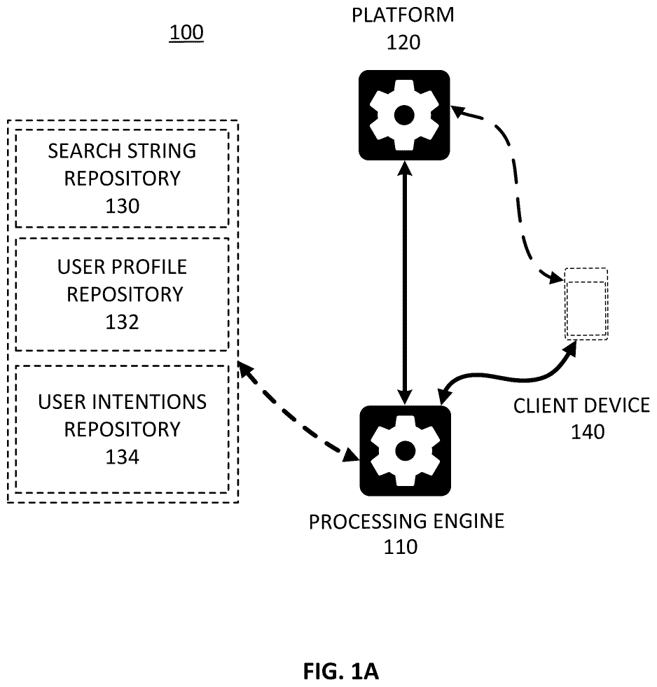

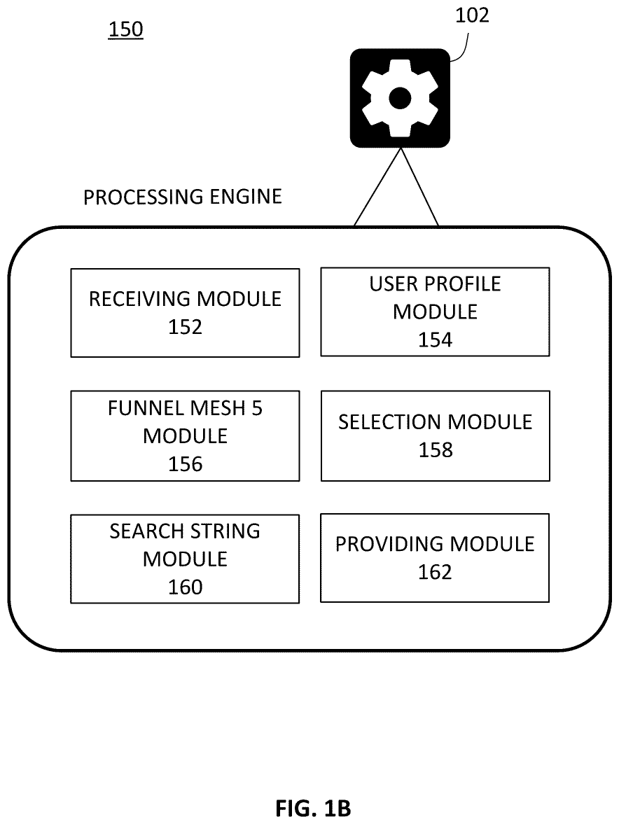

FIG. 1A is a diagram illustrating an exemplary environment in which some embodiments may operate. In the exemplary environment 100, a client device 140 is connected to a processing engine 110 and, optionally, a platform 120. The processing engine 110 is connected to the platform 120, and optionally connected to one or more repositories and/or databases, including, e.g., a search string repository 130, a user profile repository 132, and/or a user intentions repository 134. One or more of the databases may be combined or split into multiple databases. The client device 140 in this environment may be a computer, and the platform 120 and processing engine 110 may be applications or software hosted on a computer or multiple computers which are communicatively coupled via remote server or locally.

The exemplary environment 100 is illustrated with only one client device, one processing engine, and one platform, though in practice there may be more or fewer additional client devices, processing engines, and/or platforms. In some embodiments, the client device(s), processing engine, and/or platform may be part of the same computer or device.

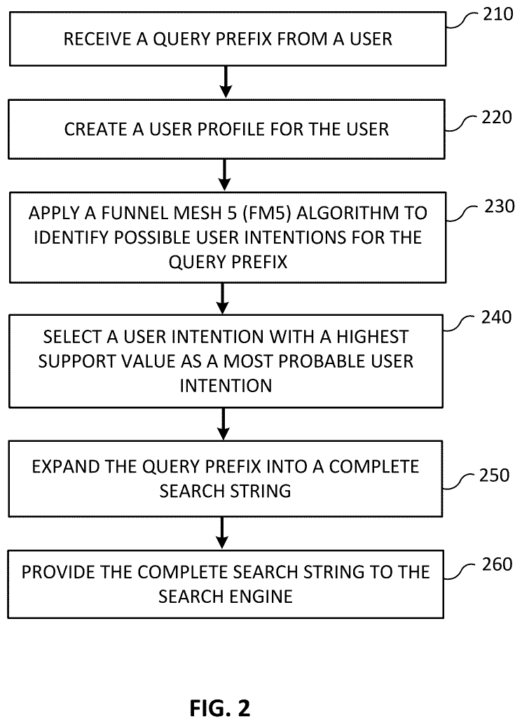

In an embodiment, the processing engine 110 may perform the exemplary method of FIG. 2 or other method herein and, as a result, provide identification of user intention and disambiguation of ambiguous search keywords using personalized user profiles and weighted algorithms. In some embodiments, this may be accomplished via communication with the client device, processing engine, platform, and/or other device(s) over a network between the device(s) and an application server or some other network server. In some embodiments, the processing engine 110 is an application, browser extension, or other piece of software hosted on a computer or similar device, or is itself a computer or similar device configured to host an application, browser extension, or other piece of software to perform some of the methods and embodiments herein.

The client device 140 is a device with a display configured to present information to a user of the device who is a user of the platform 120. In some embodiments, the client device presents information in the form of a visual UI with multiple selectable UI elements or components. In some embodiments, the client device 140 is configured to send and receive signals and/or information to the processing engine 110 and/or platform 120. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 110 and/or platform 120 may be hosted in whole or in part as an application or web service executed on the client device 140. In some embodiments, one or more of the platform 120, processing engine 110, and client device 140 may be the same device. In some embodiments, the client device 140 is associated with a first user account within a platform, and one or more additional client device(s) may be associated with additional user account(s) within the platform.

In some embodiments, optional repositories can include a search string repository 130, user profile repository 132, and/or user intentions repository 134. The optional repositories function to store and/or maintain, respectively, search strings submitted by users; user profile information for users; and predicted intentions of users for ambiguous keywords. The optional database(s) may also store and/or maintain any other suitable information for the processing engine 110 or platform 120 to perform elements of the methods and systems herein. In some embodiments, the optional database(s) can be queried by one or more components of system 100 (e.g., by the processing engine 110), and specific stored data in the database(s) can be retrieved.

Platform 120 is a platform configured for providing a search engine to a user, and further configured for identifying user intention and disambiguating ambiguous search keywords using personalized user profiles and weighted algorithms. The platform 120 may present a user with one or more user interfaces or interface components which facilitate the submission of user information and data.

FIG. 1B is a diagram illustrating an exemplary computer system 150 with software modules that may execute some of the functionality described herein. In some embodiments, the modules illustrated are components of the processing engine 110.

Receiving module 152 functions to receive a query prefix from a user, where the query prefix is an initial fragment of a search string input by the user in a search box of the search engine.

User profile module 154 functions to create a user profile for the user, the user profile including a set of parameters.

Funnel Mesh 5 module 156 functions to apply a Funnel Mesh 5 (FM5) algorithm to identify possible user intentions for the query prefix. The FM5 algorithm includes mapping the parameters of the user profile to a set of meshes; assigning weights to each of the meshes; selecting a subset of meshes based on the assigned weights, the subset representing the user profile parameters with the highest assigned weights for disambiguating the search intention; and utilizing the selected subset of meshes to identify a set of possible user intentions associated with the query prefix.

Selection module 158 functions to select a user intention from the set of possible user intentions with a highest support value as a most probable user intention for the query prefix.

Search string module 160 functions to expand the query prefix into a complete search string based on the selected user intention.

Providing module 162 functions to provide the complete search string to the search engine for generating a list of search results that are contextually relevant to the selected user intention.

The above modules and their functions will be described in further detail in relation to an exemplary method below.

FIG. 2 is a flow chart illustrating an exemplary method that may be performed in some embodiments.

At step 210, the system receives a query prefix from a user. The query prefix is an initial fragment of a search string input by the user in a search box of the search engine. Receiving a query prefix from a user involves capturing an initial portion of a search string input into a search box associated with a search engine. In various embodiments, the query prefix refers to a partial string of, e.g., alphanumeric characters, symbols, or other inputs that represent the incomplete search query of a user. A user in this context is defined as any individual or system that interacts with the search engine to retrieve information. The user initiates a search by entering a fragment of a search string, i.e., an initial portion of the full search string the user intends to submit. This fragment serves as the basis for further processing and refinement by the search engine.

The search string is a sequence of characters or terms provided by the user to instruct the search engine on the nature of the information being sought. In various embodiments, it may include, e.g., words, numbers, or symbols, depending on the query. The query prefix represents the portion of this search string entered before the user completes the query and submits it for processing. For example, if a user is searching for information on “Java programming language” but has only typed “Java pro” into the search box, the string “Java pro” constitutes the query prefix. The complete search string, in this case, would be “Java programming language.”

The search box is the graphical user interface element within the search engine that allows the user to input text for searching. In some embodiments, the search box is presented as a rectangular field where users can enter their query. The search engine, which processes the query prefix, refers to a software system designed to search large datasets or databases in response to user queries. In some embodiments, the query prefix is processed in real-time by the search engine as the user continues to input characters, allowing the search engine to make predictions or suggestions based on the partial query.

In some embodiments, upon receiving the query prefix, the search engine does not wait for the full search string to be entered; instead, it processes the fragment immediately. This immediate response allows for further refinement of the query by disambiguating the intent behind the partial string. The interaction between the user and the search engine remains dynamic, as the query prefix evolves with each additional character or term typed into the search box.

At step 220, during or prior to the search process, the system creates a user profile for the user, with the user profile including a set of parameters. In various embodiments, the user profile is a structured data entity associated with a specific user, storing relevant information about the user that may be utilized by the system to personalize or contextualize the search process. In various embodiments, the user profile can be created during an initial registration process, or generated based on prior interactions with the system. In some embodiments, this profile is stored in a database associated with the search engine and is linked to a unique identifier of the user, such as, for example, a login ID or session token.

The user profile contains a set of parameters, which are predefined attributes that can describe various aspects of, for example, the preferences, behaviors, and demographics of the user. In some embodiments, these parameters are discrete data points used by the system to influence the search results and improve the identification of user intent. In various embodiments, examples of such parameters may include, but are not limited to, profession, interests, gender, location, and past searches. In some embodiments, each parameter in the user profile may be populated through explicit input by the user, such as providing their profession during registration, or implicitly through analysis of the past interactions of the user with the search engine.

In some embodiments, each parameter in the user profile is assigned a value, either through direct user input or through analysis of the system. For instance, the “profession” parameter may be assigned the value “Engineer,” while the “location” parameter may be assigned the value “India” based on user-provided data or geolocation tracking. The “past searches” parameter may record a history of the prior search queries of the user within the search engine, allowing the system to infer patterns or preferences in the user's search behavior. In some embodiments, these parameters are stored in a structured format within the user profile, enabling the system to access and update them as required.

In some embodiments, the user profile is dynamically updated as new information becomes available. For example, if the user conducts a new search, the “past searches” parameter may be updated to reflect the new query. Additionally, certain parameters may be weighted more heavily depending on the search context. For instance, in cases where the user is searching for leisure-related topics, parameters such as “interests” may take precedence over “profession” when identifying the user's intent. The parameters stored in the user profile form the basis for applying personalization in the search process, allowing the system to refine and adjust the search results based on the specific characteristics and preferences of the user.

At step 230, the system applies a Funnel Mesh 5 (FM5) algorithm to identify possible user intentions for the query prefix. The FM5 algorithm is a computational method designed to analyze the user profile in conjunction with the query prefix in order to infer multiple potential interpretations, or user intentions, of the ambiguous or incomplete query. A user intention refers to the underlying objective or context that the user may have when entering a query, which could vary based on the meaning of the words in the query and the user's individual preferences or background as stored in the user profile.

The FM5 algorithm operates by structuring the analysis of user profile data through a multi-layered filtering process, referred to as a funnel. In this funnel structure, different parameters from the user profile are considered sequentially, narrowing down the range of possible interpretations of the query prefix. Each “mesh” in the funnel represents a specific user profile parameter, such as profession, interests, or location, and serves to refine the possible user intentions associated with the query prefix. The funnel structure of FM5 ensures that user intentions are systematically evaluated in a step-wise manner, filtering through the layers of the funnel as parameters are applied.

At a high level, the FM5 algorithm generates a set of potential user intentions by comparing the query prefix to data within the user profile. For example, if the query prefix is “Java,” the algorithm might generate user intentions related to “Java programming language,” “Java coffee,” or “Java island,” depending on how the parameters in the user's profile interact with the possible meanings of “Java.” The algorithm does not immediately select a single interpretation but instead evaluates multiple possibilities based on the stored user profile information. These potential user intentions are then processed further in later steps to select the most likely interpretation.

The primary role of the FM5 algorithm at this stage is to organize and evaluate the possible user intentions in a structured and multi-faceted way, ensuring that all relevant parameters of the user profile are considered. This allows the system to maintain flexibility in interpreting the query prefix and to handle ambiguous queries where multiple interpretations are feasible. The output of this step is a set of possible user intentions, which are then subjected to further analysis to determine the most appropriate one for completing the search query.

The FM5 algorithm includes mapping the parameters of the user profile to a set of meshes. In this context, mapping refers to the assignment of each user profile parameter, such as, e.g., profession, interests, gender, location, and past searches, to individual logical structures called meshes. Each mesh represents a filter or layer within the overall funnel, through which the possible user intentions are refined. By associating the profile parameters with specific meshes, the FM5 algorithm enables the system to systematically process different aspects of the user's profile when identifying possible user intentions for the query prefix.

The set of meshes in the FM5 algorithm operates as a multi-layered filtering mechanism. Each mesh corresponds to one of the profile parameters, and the structure of these meshes allows the system to selectively apply or ignore certain parameters depending on the current search context. For example, a mesh corresponding to the “profession” parameter may be used to filter user intentions related to a search prefix, such as “Java,” by determining whether the user's profession is relevant to the term's meaning. In this case, a user with the profession of “software engineer” might have the term “Java” mapped to the context of programming languages, while a user without such a profession might map the term to a different context, such as coffee or geography.

In some embodiments, the mapping of profile parameters to meshes also enables the system to assign varying levels of importance to different parameters based on the current search. Each mesh can act as an independent layer that contributes to narrowing down the range of possible user intentions. For instance, a mesh for the “location” parameter may determine whether a user's geographic location influences the interpretation of the query prefix. A user located in Indonesia might have “Java” associated with the island, while a user in a different location might have different interpretations. By mapping each profile parameter to a corresponding mesh, the FM5 algorithm structures the process of filtering user intentions in a scalable and organized way, ensuring that all relevant parameters are considered during the disambiguation process.

In some embodiments, the FM5 algorithm includes assigning weights to each of the meshes. A “weight” in this context refers to a numerical value that is assigned to each mesh, representing the relative significance of the corresponding user profile parameter in the context of disambiguating the query prefix. The weights are used by the system to prioritize certain parameters over others when identifying potential user intentions. These weights may be predetermined based on general rules or dynamically adjusted based on real-time data, such as the specific characteristics of the current query or historical behavior of the user.

The process of assigning weights to the meshes allows the FM5 algorithm to adjust the influence of each user profile parameter based on the search context. For example, if a user enters a query prefix related to a professional term, such as “Python,” the system may assign a higher weight to the “profession” mesh for users whose profile indicates a technical profession, such as software engineering. Conversely, for a non-technical user, the weight assigned to the “interests” mesh may be higher, indicating that the term “Python” is more likely to be associated with the animal rather than the programming language. The weights help the system determine which meshes should have more influence when evaluating possible user intentions.

In some embodiments, the FM5 algorithm uses these weights to create a prioritized structure for filtering potential user intentions. Each mesh, representing a user profile parameter, is weighted according to its importance, and the system applies these weights to compute a cumulative score for each potential user intention. Higher-weighted meshes contribute more to the final determination of user intention, whereas lower-weighted meshes have a reduced impact. For instance, in a search where “location” is less relevant, the mesh corresponding to the “location” parameter may be assigned a lower weight, reducing its influence in the decision-making process. By assigning weights to each mesh, the FM5 algorithm ensures that the most contextually relevant user profile parameters are emphasized during the analysis of the query prefix.

In some embodiments, the weights assigned to the meshes are calculated using a predefined weighting function that considers historical search patterns associated with each parameter. A weighting function is a mathematical formula or algorithm used to assign numerical weights to different parameters in the user profile. These weights influence how each parameter contributes to the identification of the user's intention during the search process. In this embodiment, the weighting function is predefined, meaning it is designed in advance and incorporates historical data regarding the user's search behavior and interactions with the system.

The historical search patterns considered in the weighting function include the frequency and context of the user's past searches for specific keywords or topics, as well as the overall relevance of certain parameters like profession or location to previous search outcomes. For example, if a user consistently searches for technical subjects related to their profession, the weighting function may assign a higher weight to the “profession” parameter when the system processes future queries.

In some embodiments, the system adjusts the assigned weights based on the time of day or date of the search, where time-sensitive user intentions are given higher priority. This adjustment involves dynamically modifying the weights assigned to the meshes that correspond to the user profile parameters, based on temporal factors such as when the query is submitted. Time-sensitive factors can significantly impact user intentions, as certain queries may be more relevant or contextually dependent on the specific time or date. In some embodiments, the system monitors the time of day and date when the user initiates the query and uses this temporal information to adjust the weights of specific parameters accordingly. For example, a user who enters the query prefix “football” in the evening might have a higher weight assigned to the “interests” parameter if there is an ongoing football match. Alternatively, if the query prefix is entered on a weekend, the system may adjust the weights to prioritize leisure-related intentions over professional ones. The adjustment ensures that the user's profile parameters are evaluated in a way that reflects the likely context of the query at that specific time.

In some embodiments, the FM5 algorithm includes selecting a subset of meshes based on the assigned weights, the subset representing the user profile parameters with the highest assigned weights for disambiguating the search intention. In some embodiments, this involves evaluating the weights assigned to each mesh, which correspond to specific user profile parameters, and identifying those meshes whose weights meet a predetermined threshold or rank the highest. The selection process serves to narrow down the number of profile parameters considered during the disambiguation of the query prefix, focusing only on the most influential parameters for determining the user's intention.

The subset of meshes is chosen dynamically depending on the context of the search query and the user's profile. For example, if the query prefix is vague or highly ambiguous, such as “Java,” and the user's profile has multiple parameters that could influence the interpretation, the system evaluates the assigned weights for each mesh. If the “profession” and “location” meshes have the highest weights, indicating that the user's profession and geographic location are the most relevant factors for this particular search, the system selects those meshes for further processing. Other meshes, such as “gender” or “past searches,” may be excluded from the subset if their weights are lower and considered less relevant to the disambiguation of the query.

In some embodiments, the FM5 algorithm incudes utilizing the selected subset of meshes to identify a set of possible user intentions associated with the query prefix. Once the subset of meshes with the highest assigned weights is selected, these meshes are applied to filter and evaluate the query prefix against the user profile parameters. Each mesh in the selected subset represents a key profile parameter, such as profession or location, that is deemed most relevant to disambiguating the query prefix. By processing the query prefix through the selected subset of meshes, the system generates a list of potential interpretations, i.e., user intentions.

The utilization of the selected subset of meshes is a structured process, where each mesh acts as a filter for narrowing down the possible user intentions. In various embodiments, as each mesh corresponds to a user profile parameter, the FM5 algorithm applies the meshes sequentially to the query prefix, resulting in a set of user intentions that align with the user's profile. In various embodiments, this set of possible user intentions is not yet finalized; instead, it represents a range of likely meanings for the query prefix, which will undergo further refinement based on additional factors such as past searches, support values, or external context.

In some embodiments, the FM5 algorithm is adapted to process user profiles and search queries in different languages. This means the algorithm may be capable of handling multilingual data, allowing the system to identify user intentions and perform query expansion across various languages. The adaptation of the FM5 algorithm for multilingual support involves enabling the system to interpret and process user profile parameters and query prefixes in a variety of linguistic contexts, ensuring that the method functions effectively regardless of the language used in the input.

At step 240, the system selects a user intention from the set of possible user intentions with a highest support value as a most probable user intention for the query prefix. A “support value” is a numerical metric that quantifies the relevance or frequency of each user intention within the set. In some embodiments, this value is calculated by analyzing historical data, such as, for example, the user's past searches, interaction patterns, or external usage trends, and comparing it against the possible interpretations generated from the query prefix. The support value acts as a statistical measure to determine which user intention is most likely aligned with the current query.

In some embodiments, the selection process involves ranking the set of possible user intentions according to their support values. Each user intention is evaluated, and the system assigns a support value based on the confidence that this intention correctly represents the user's underlying purpose. For instance, if the query prefix is “Java” and the user's profile indicates a profession in software engineering, the support value for “Java programming language” might be higher than “Java coffee” or “Java island.” The intention with the highest support value is considered the most probable, and the system designates it as the final user intention for the query prefix.

In some embodiments, selecting the user intention with the highest support value includes applying an association rule mining technique to compute the support value for each user intention in the set of possible user intentions. “Association rule mining” is a data mining technique used to discover relationships between variables in large datasets. In this context, it is employed to identify correlations between the user's profile parameters and the possible user intentions derived from the query prefix. The support value represents the strength or frequency of a particular user intention relative to other potential intentions, as determined by the patterns found in the user's past behavior and similar users'profiles. The association rule mining technique functions by analyzing the co-occurrence of user profile parameters—such as, e.g., profession, interests, and location—and their relationship to the query prefix and possible user intentions. The system processes this data to identify frequent patterns or rules that suggest a strong likelihood of a particular user intention being relevant. For example, if a user frequently searches for programming-related topics and enters the query prefix “Python,” the system may use association rule mining to recognize that users with similar profiles and search patterns typically intend to search for “Python programming language.” This association is then used to compute the support value for that specific user intention.

In some embodiments, the association rule mining technique utilizes a support-confidence framework to identify strong correlations between the user profile parameters and the intended search outcomes. A support-confidence framework is a commonly used method in association rule mining that quantifies both the frequency of a particular pattern and the reliability of the association. In this case, “support” measures how frequently a specific user intention occurs in conjunction with certain user profile parameters, while “confidence” evaluates the strength of the association between those parameters and the expected search outcome. The “support” metric quantifies how often a particular user intention, such as “Java programming language,” appears in relation to a set of user profile parameters, such as profession, interests, and past searches. For example, if a large number of users with the profession of software engineering have historically searched for “Java programming language,” the support for that intention in relation to the query prefix “Java” would be high. The “confidence” metric, on the other hand, measures how likely it is that the user's current query prefix will result in a specific user intention, based on the observed relationship between their profile parameters and past outcomes. A high confidence score indicates a strong correlation between the profile parameters and the intended search outcome.

In some embodiments, the selection of the user intention involves a secondary filtering process that compares the identified user intention against a database of previously resolved ambiguous search queries. This step involves an additional layer of validation, where the system leverages a historical database containing search queries that were previously ambiguous but were successfully resolved based on similar user profiles or search contexts. The secondary filtering process allows the system to cross-check the current user intention against patterns from prior cases, ensuring that the final selected user intention is consistent with how similar queries were interpreted in the past. The database of previously resolved ambiguous search queries is a repository of past searches that includes not only the original query inputs but also the corresponding resolved intentions. This database contains mappings between ambiguous query prefixes and the user intentions that were ultimately selected, along with associated user profiles and context. For example, if a query prefix such as “Python” was previously resolved as “Python programming language” for users with similar profiles, this information is stored and used as a reference during the secondary filtering process for future queries involving the same prefix.

In some embodiments, the search engine can provide real-time or near-real-time feedback to the user on the identified intention and allows the user to manually confirm or adjust the intention before finalizing the search string. In some embodiments, the system can dynamically display information about the identified user intention as the user inputs their query, without requiring the user to submit the full search string first. This feedback is displayed in the search interface, enabling the user to see which user intention has been identified based on the current query prefix. The real-time or near-real-time feedback allows the user to interact with the system as the query prefix is being processed. For example, when the system identifies a user intention such as “Java programming language” based on the input “Java pro,” the system displays this inferred intention in a visible area near the search box. If the displayed intention aligns with the user's actual intention, the user can confirm it, allowing the system to proceed with query expansion and generating search results. If the identified intention is incorrect or not fully aligned with what the user intends, the system provides an option for manual adjustment, where the user can select a different intention from a list of alternate possibilities or directly input their desired intention.

At step 250, the system expands the query prefix into a complete search string based on the selected user intention. The query prefix is used as the starting point for constructing a “complete search string,” which is the full, disambiguated version of the search query that the system will submit to the search engine. In some embodiments, the expansion process involves appending or modifying the query prefix with additional terms that align with the selected user intention, thereby transforming the partial input into a coherent and contextually appropriate search query.

The expansion of the query prefix is driven by the user intention previously identified as the most probable from the set of possible intentions. For example, if the query prefix is “Python” and the selected user intention is “Python programming language,” the system may expand the query prefix by adding terms such as “programming language” or “software tutorial” to refine the query. The resulting search string, such as “Python programming language tutorial,” is more specific and targeted, allowing the search engine to retrieve results that are directly relevant to the user's intended meaning.

In some embodiments, the expansion process is flexible and dynamic, allowing the system to incorporate various types of contextual information during query construction. The system may draw from external resources such as thesauri, query suggestion databases, or previous searches to determine the most appropriate terms to append or modify. For example, if a user intention involves a specific location or timeframe, such as “Java island tourism,” the system might expand the query prefix by adding location-based or time-sensitive terms to generate a more precise search string, such as “Java island tourism in 2024.”

In some embodiments, the complete search string includes context-specific keywords that are automatically selected based on the identified user intention. After the system identifies the most probable user intention, it enhances the query prefix by incorporating additional keywords that provide context and clarify the meaning of the search. These context-specific keywords are chosen to refine the query and make it more precise, ensuring that the search engine can retrieve results that better match the user's inferred intent. In some embodiments, the context-specific keywords are derived from various sources, including, e.g., the user's profile parameters, historical search patterns, or predefined keyword databases related to the subject matter of the query. For instance, if the user enters the query prefix “Java” and the system identifies the user intention as “Java programming language,” it may automatically append keywords such as “tutorial,” “coding,” or “software development” to the search string. In some embodiments, these keywords are chosen to reflect the most relevant aspects of the user's intention, as inferred from the user profile, and are added without requiring explicit input from the user.

In some embodiments, the query expansion is performed iteratively, refining the search string with each successive character input by the user until the full search string is composed. “Iteratively” refers to a step-by-step process where the system dynamically updates and adjusts the search string as the user continues typing. With each new character entered into the search box, the system reassesses the query prefix in real-time, modifying the search string as it gathers more information about the user's input and adjusts the identified user intention accordingly.

The iterative nature of query expansion allows the system to refine its understanding of the user's intended search as additional characters are typed. For example, if the user begins by typing “Java,” the system may initially expand the query with possible intentions such as “Java programming” or “Java coffee.” As the user continues typing, adding characters such as “pro,” the system recognizes the prefix as “Java programming” and further narrows down the expansion to “Java programming language” or related terms. The search string is continuously adjusted with each character input, providing increasingly specific expansions that reflect the evolving context of the query.

At step 260, the system provides the complete search string to the search engine for generating a list of search results that are contextually relevant to the selected user intention. The complete search string is the fully expanded version of the original query prefix, refined based on the user's profile and the selected user intention. This search string is transmitted to the search engine, which processes the string to retrieve matching documents, websites, or other resources from its indexed data. The search engine uses the string as the primary input for its search algorithms, which evaluate the relevance of various documents to the terms and structure of the search string.

In some embodiments, the search engine, as a computational system designed to index, search, and retrieve information, applies its internal algorithms to rank and filter potential results. In various embodiments, these algorithms may consider factors such as, e.g., keyword relevance, page content, metadata, and links, among other criteria. In this step, the system provides the search string in a structured format compatible with the search engine's indexing and retrieval processes. For example, if the complete search string is “Java programming language tutorial,” the search engine will search its indexed data for relevant results, prioritizing pages or documents that are strongly associated with those terms and the underlying user intention of learning about the programming language.

The list of search results generated by the search engine is filtered and ranked based on the search string, but the relevance of the results is also directly influenced by the selected user intention. The search engine's response to the search string incorporates contextual factors inferred from the user's intention, such as professional or interest-based relevance. For example, if the user intention was identified as “Java programming language,” the search results are expected to be strongly aligned with that topic, and irrelevant results—such as those related to “Java coffee”—are deprioritized or excluded. The system ensures that the search engine produces results that are in line with the user's most probable intention, enhancing the accuracy and relevance of the retrieved information.

In some embodiments, the system presents the search results to the user in a ranked list format, where higher-ranking results are displayed more prominently. These results are tailored to reflect the user's selected intention and query context, allowing the user to browse through relevant information based on the original search query.

In some embodiments, the system logs the identified user intention and the corresponding search results for future use in refining the FM5 algorithm. “Logging” refers to the process of systematically recording data about the selected user intention and the search results generated in response to that intention. This information is stored in a database or log file, where it can be retrieved and analyzed later to improve the accuracy and performance of the FM5 algorithm. In some embodiments, the logging operation captures both the user intention that was selected based on the query prefix and the list of search results returned by the search engine in response to the expanded search string. This logged data includes specific details such as the query prefix entered by the user, the profile parameters used to identify the user intention, the exact intention selected, and the set of search results that were generated. For example, if the system identifies “Java programming language” as the user intention and provides a set of programming-related search results, this information is logged for future reference. The system tracks this interaction to improve how it handles similar queries or user profiles in the future. In some embodiments, the stored logs are used to refine the FM5 algorithm by providing a historical dataset that can be analyzed to detect patterns and trends. By examining the logged user intentions and corresponding search results, the system can identify areas where the FM5 algorithm may need adjustment or improvement. For instance, if the system frequently selects an incorrect user intention for a certain type of query or fails to provide relevant search results, this pattern can be flagged during future analysis. The logged data can be used to retrain the FM5 algorithm or adjust its weighting functions, improving its accuracy in identifying user intentions and generating more relevant search results over time.

In some embodiments, the system employs machine learning techniques to continuously improve the accuracy of the FM5 algorithm in predicting user intentions based on ongoing user interactions and search outcomes. Machine learning techniques refer to algorithms that automatically learn and adapt from data, allowing the system to enhance its performance over time without explicit reprogramming. In this context, machine learning is applied to refine the FM5 algorithm's ability to accurately identify and predict user intentions based on the analysis of user behavior and search result patterns. In some embodiments, the system gathers data from each user interaction, including the user's query inputs, selected user intentions, and the corresponding search results. This data is fed into the machine learning model, which analyzes patterns and correlations between user profiles, query prefixes, and search outcomes. For example, if the system frequently identifies a certain user intention for a specific query prefix but users often select alternative intentions or adjust the results manually, the machine learning algorithm adjusts its predictions by recognizing these patterns. Over time, the system becomes more adept at predicting user intentions for future queries by learning from previous searches.

In some embodiments, the system also evaluates the effectiveness of the search results generated from the expanded search strings. If users tend to click on certain search results more frequently, or if specific user intentions consistently lead to relevant results, the machine learning model incorporates this feedback to refine the FM5 algorithm's selection process. This enables the system to better weigh the user profile parameters and improve the accuracy of the selected user intention. For example, if users with similar profiles regularly intend to search for “Java programming” when inputting the prefix “Java,” the system learns this behavior and prioritizes this intention in future predictions for similar users.

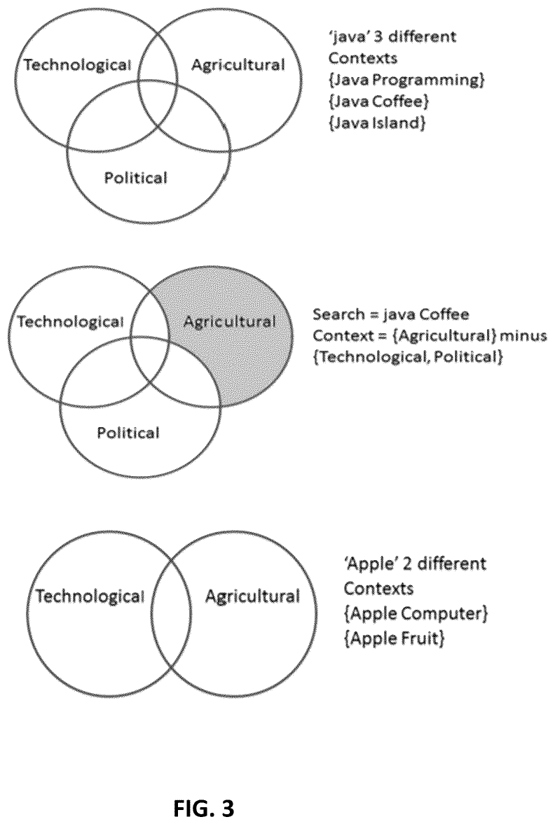

FIG. 3 is a diagram illustrating ambiguous keywords having multiple contextual interpretations, in accordance with some embodiments. The multiple contextual interpretations can be categorized into different contextual domains. The figure presents two key examples, “java” and “apple,” showing how such ambiguous terms can belong to various contexts—technological, agricultural, and political. The Venn diagrams in each section of the figure represent these contextual domains, with overlapping areas indicating intersections between these contexts, allowing for multiple interpretations of a single term.

In the top portion of FIG. 3, the term “java” is shown to exist in three different contexts: Java Programming, Java Coffee, and Java Island. These contexts fall within the technological, agricultural, and political domains, respectively. The Venn diagram illustrates these domains as three overlapping circles. The intersections between the circles demonstrate that “java” may be interpreted differently depending on the context that is most relevant to the user's intention. For example, if a user searches for “java,” the system will identify the possible interpretations and select the one that aligns with the user's profile and query context.

The middle section of FIG. 3 shows a refinement of the search process when the user's intent is determined to be “Java Coffee.” In this case, the relevant context is identified as Agricultural, while the Technological and Political contexts are excluded. The shaded area in the diagram highlights the agricultural domain, indicating that the system has filtered out the other contexts, which are irrelevant to the current search. This demonstrates the disambiguation process where irrelevant contexts are systematically removed to focus on the user's most probable intention.

In the bottom section of FIG. 3, the term “apple” is shown to have two different contexts: Apple Computer and Apple Fruit. The Venn diagram shows only two overlapping circles, representing the Technological and Agricultural domains. In this case, the system will interpret the query based on the user's profile and current context to determine whether the user is searching for information about Apple Inc. or the fruit. This illustrates how the system dynamically applies contextual filters to resolve ambiguity in keywords with multiple possible meanings, ensuring that the correct context is used to generate relevant search results.

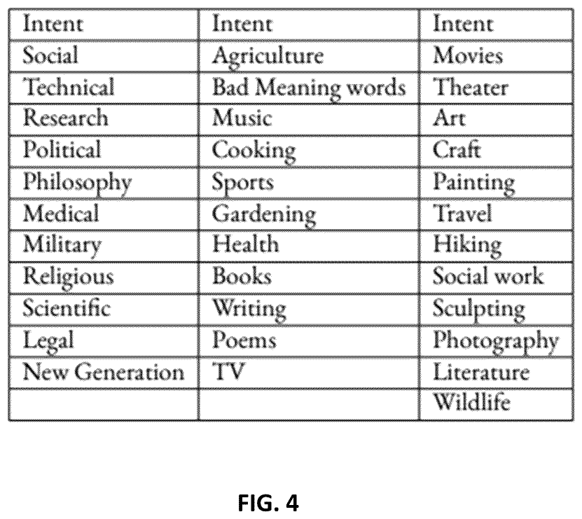

FIG. 4 is a diagram illustrating an intention matrix, in accordance with some embodiments. The intention matrix is where various user intentions can be categorized across different domains. Each cell in the matrix represents a potential area of user interest or activity, which the system can use to classify and disambiguate search queries. The matrix enables the system to map ambiguous keywords or query prefixes to specific user intentions, drawing from a wide range of topics such as social, technical, medical, and artistic fields.

In various embodiments, the system uses this matrix to store and analyze potential user intentions by associating user profiles with specific cells in the matrix. When a user enters a query prefix, the system cross-references the profile information (such as profession, interests, or location) with the intention categories in the matrix to predict which category best matches the user's intended search outcome. For example, if a user with a known interest in “Music” enters a vague query like “classical,” the system can use the matrix to determine that the likely user intention relates to musical topics rather than scientific or technical ones.

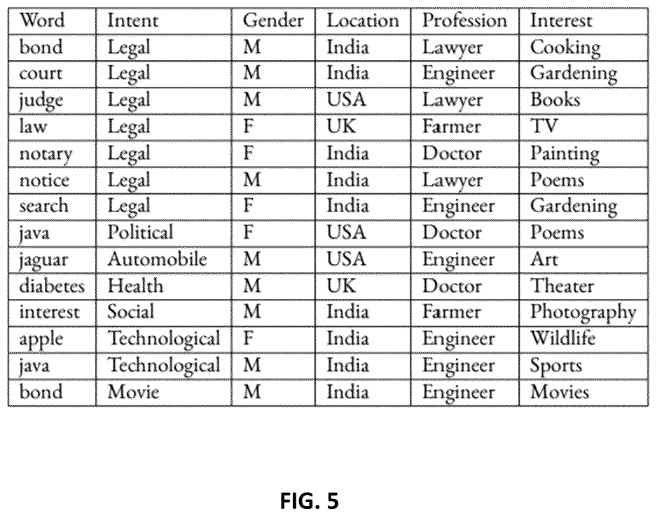

FIG. 5 is a diagram illustrating example data which may be utilized for user intention identification, in accordance with some embodiments. The table shown demonstrates how the system processes a variety of factors, including, e.g., the ambiguous word itself, the user's gender, location, profession, and interests, to determine the most likely user intention associated with a query. This structured data allows the system to resolve ambiguity and refine search results by aligning query interpretations with the user's specific profile attributes.

The first column in the table lists various ambiguous terms, such as “bond,” “court,” “jaguar,” and “java,” each of which can have multiple meanings depending on context. For instance, “bond” can be associated with the legal or movie context, while “jaguar” can refer to either an automobile or an animal. The second column provides the user intent for each term, showing how the system interprets the ambiguous word based on the user's profile. For example, “jaguar” is listed with the intent “Automobile” for one user and “Wildlife” could be an interpretation for a different user with a relevant profile.

The additional columns detail user profile parameters such as gender, location, profession, and interests, all of which are used to disambiguate the search terms. For example, for the word “jaguar,” the table shows the user is male, located in the USA, with a profession as an engineer, and an interest in art. Based on this profile, the system has identified “Automobile” as the most probable intention. Conversely, if the user had interests aligned with wildlife or biology, the intention might shift toward “Wildlife.”

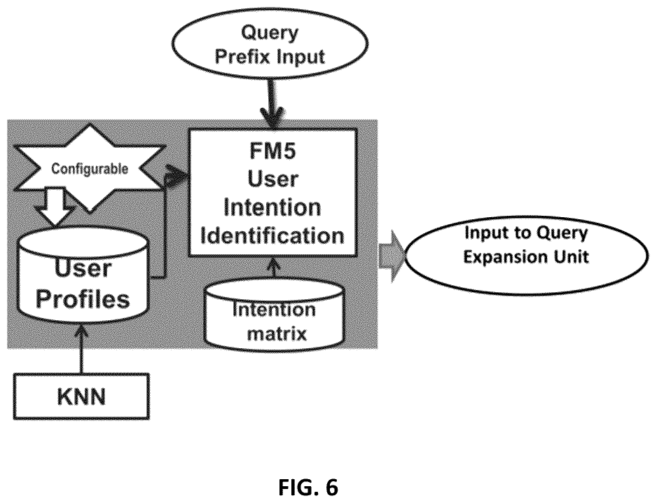

FIG. 6 is a diagram illustrating the user intention identification process and query autocompletion, in accordance with some embodiments. This is integrated with the FM5 algorithm, user profiles, and query expansion. The diagram outlines how a query prefix is processed to identify the user's intention and how this leads to query expansion. The figure shows the flow of data from the query prefix input through the FM5 algorithm and into the query expansion system, with user profiles and an intention matrix playing crucial roles in refining and disambiguating the user's query.

At the top of FIG. 6, the Query Prefix Input is the initial fragment of a search string entered by the user into a search box. This input triggers the process, and the query prefix is sent directly into the FM5 User Intention Identification unit. The FM5 algorithm is tasked with determining the user's probable intention based on the partial input. The system uses two key sources to identify user intentions: the User Profiles database and the Intention Matrix. These two resources help filter possible intentions by mapping user-specific characteristics to the context of the query prefix.

To the left of the FM5 unit, User Profiles contain structured information about the user, such as profession, interests, location, gender, and past search behavior. This data is configurable and personalized for each user, and it assists in guiding the FM5 algorithm's interpretation of ambiguous query prefixes. For example, a user with a profile indicating a profession in software engineering is more likely to search for “Java programming” when typing “Java” into the search box, as opposed to “Java coffee” or “Java island.” The K-Nearest Neighbors (KNN) model is employed to enhance the accuracy of this matching process by comparing the current user's profile with similar profiles from the user base to better predict the intention.

The Intention Matrix, shown below the FM5 unit, stores potential meanings and contexts for ambiguous terms, such as “jaguar” or “apple.” When the FM5 algorithm receives the query prefix, it checks the matrix for matching contexts and cross-references these with the user profile to prioritize the most relevant interpretation. The system then outputs a refined user intention, which serves as an input to a query expansion unit. The query expansion unit will take the identified user intention and expand the query prefix into a full search string, enabling more accurate and personalized search results based on the user's intent.

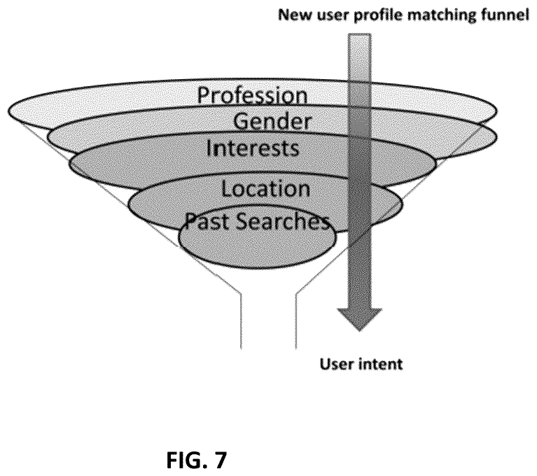

FIG. 7 is a diagram illustrating a personalization funnel used to identify user intent by filtering through multiple user profile parameters, in accordance with some embodiments. The funnel structure visually represents how user data is processed in layers, with each layer corresponding to a specific user profile attribute. As the system filters through these attributes, it narrows down the possible user intentions, progressively refining the query interpretation until the most relevant user intent is identified at the bottom of the funnel.

The layers of the funnel in FIG. 7 are labeled as Profession, Gender, Interests, Location, and Past Searches, with each layer representing a key user profile parameter. Starting at the top of the funnel, the system first considers broad attributes like Profession, which may help eliminate irrelevant contexts for the query. For example, if a user is a software engineer, their profession will heavily influence how the system interprets ambiguous terms like “Java” (e.g., likely referring to programming rather than coffee).

As the system moves through the funnel, additional parameters such as Gender and Interests are applied to further refine the interpretation. These parameters are narrower and more context-specific, enabling the system to determine the user's current search intent. For instance, a user with an interest in wildlife might search for “jaguar” with the intent to find information about the animal, rather than the car brand. Each layer reduces the potential interpretations based on the user's profile data.

The funnel continues down through Location and Past Searches, where the system uses these parameters to finalize the user's intent. Location can play a role in interpreting terms with geographic relevance, while Past Searches provide historical context, enabling the system to predict intentions based on previous interactions with the search engine. If a user frequently searches for travel-related content, for example, the system will give higher priority to related interpretations when processing new queries.

The final step of the funnel leads to the determination of User Intent. This process is configurable, meaning additional profile parameters can be added to the funnel depending on the specific use case or requirements. The flexibility of this funnel allows the system to dynamically adapt to various user behaviors and contexts, ensuring that the identified user intent is as accurate and personalized as possible.

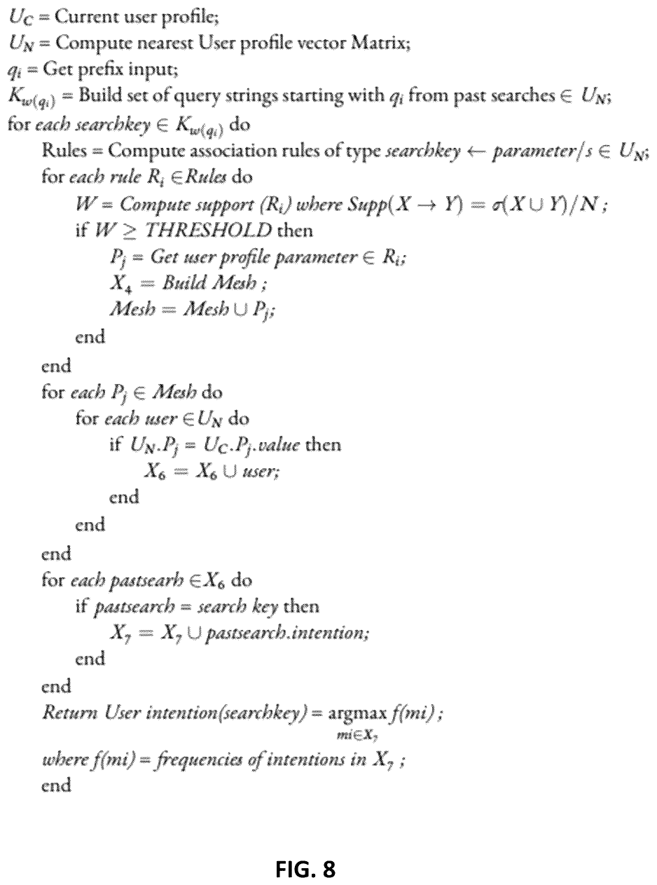

FIG. 8 is a diagram illustrating an FM5 user intention identification algorithm, in accordance with some embodiments. The algorithm begins by taking the user's query prefix and identifying related search queries from past searches. It compares the current user's profile with other similar profiles stored in a user profile matrix.

The system then computes associations between the user's query and various user profile parameters, such as profession or interests, to narrow down possible interpretations of the query. It checks how often certain terms and profile parameters appear together, and if the association is strong enough, those parameters are considered relevant for the current query.

Next, the algorithm identifies users with similar profiles and examines their past search queries to see if they align with the current query. By analyzing how other users with similar profiles have searched in the past, the system refines its understanding of the user's intent.

Finally, the algorithm selects the most likely user intention based on the frequency of similar searches and returns that as the final interpretation of the user's query. This process helps the system provide personalized and contextually accurate search results.

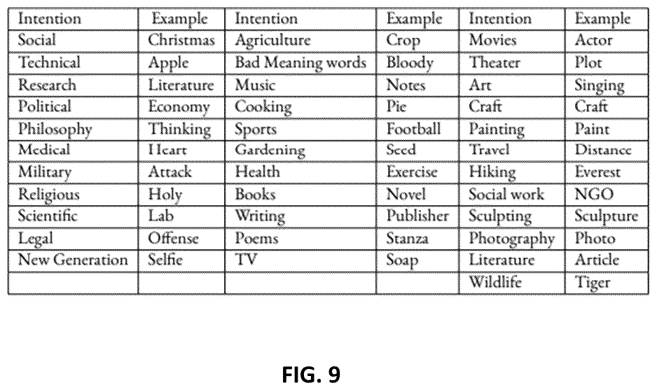

FIG. 9 is a diagram illustrating user intention categories and examples, in accordance with some embodiments. The diagram depicts a table that categorizes user intentions into various domains, along with corresponding examples for each category. The table is used by the system to map ambiguous search queries to relevant user intentions based on context and user profile data. Each row in the table represents a different Intention category, while the adjacent Example column provides specific instances of terms or queries that fall under that category.

The first column shows a variety of user intention categories, such as Social, Technical, Research, Political, and Medical, which represent broad areas of user interest or activity. Each of these categories is associated with an Example of a term that might fit within that intention. For instance, under Social, an example could be “Christmas,” indicating a potential holiday-related search. Similarly, under Technical, the example “Apple” might refer to either the technology company or the fruit, depending on the context provided by the user profile.

Further down the table, categories such as Philosophy, Military, Religious, and Scientific are also listed, each with its own examples. For example, under Philosophy, “Thinking” is shown as a sample search term, while under Scientific, “Lab” is an example. These examples help the system interpret queries that may otherwise be ambiguous, providing a contextual reference based on the user's intent category.

The rightmost portion of the table includes additional intention categories such as Movies, Art, Sports, Travel, and Wildlife, each with corresponding examples. For instance, under Movies, an example might be “Actor,” while under Wildlife, “Tiger” serves as an example. These categories and examples help the system narrow down user intentions based on the specific context of the query, allowing it to generate more relevant search results by aligning the query with the user's profile and historical searches.

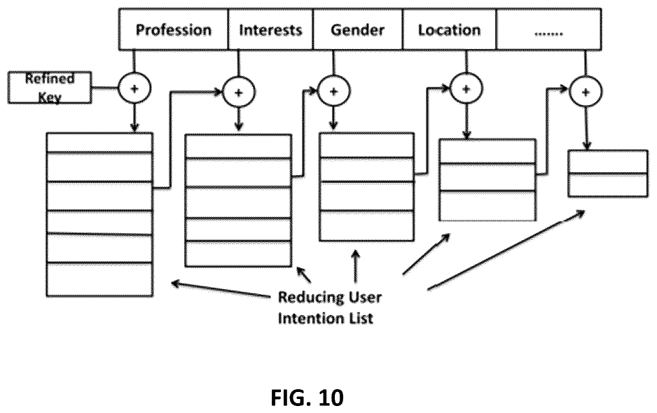

FIG. 10 is a diagram illustrating user intention identification, in accordance with some embodiments. The diagram illustrates how the system progressively filters potential user intentions using multiple profile parameters. User profile attributes, such as, e.g., Profession, Interests, Gender, Location, and others, are used to refine a list of possible intentions by applying a series of filters. As the user profile parameters are applied, the list of potential user intentions is continuously narrowed down until a final set of matching intentions is identified.

At the top of the diagram, the parameters like Profession, Interests, Gender, and Location represent key attributes that the system considers when disambiguating user queries. Each of these parameters is weighted based on its relevance to the user's current query, using a metric called “support.” Only parameters with a support value greater than a predefined threshold are used in the filtering process, meaning that the system gives more weight to the parameters that are most likely to help identify the user's intention.

As the process moves forward, each parameter contributes to reducing the list of potential user intentions. For example, when the system applies the Profession filter, it eliminates user intentions that do not align with the user's profession. This process is repeated for each subsequent parameter—such as Interests, Gender, and Location—with each step narrowing the list further. The system performs this “mesh filtering” by systematically removing unlikely matches based on the user profile data, ultimately producing a smaller set of relevant intentions (i.e., reducing the list of user intentions).

The final list of user intentions is derived using a statistical technique based on central tendency, which ensures that the most frequently occurring or central intention is selected from the refined list. This process enables the system to focus on the most relevant user intentions by continuously reducing the set of possibilities through successive application of weighted profile parameters. As a result, the system can accurately predict user intentions, even for ambiguous or incomplete search queries.

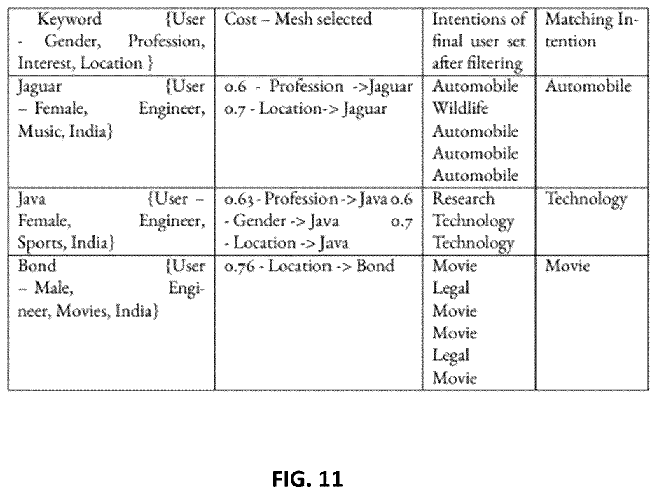

FIG. 11 is a table illustrating example test cases processed by the FM5 algorithm, in accordance with some embodiments. Three example test cases are depicted, each demonstrating how the system identifies user intentions for ambiguous keywords. The table consists of four columns: the keyword and user profile details, the selected mesh parameters (i.e., association rules) with their respective costs (i.e., support values), the filtered intentions based on the meshes, and the final matching intention returned by the system.

The first row shows the keyword “Jaguar” entered by a user who is female, an engineer, with an interest in music, and located in India. The FM5 algorithm computes the support for association rules linking the user profile parameters to the keyword. Only two rules meet the threshold, resulting in the selection of the profession and location meshes. After filtering through these meshes, five intentions related to “Jaguar” are identified: Automobile and Wildlife appear multiple times. Based on the frequency of past searches, the system returns “Automobile” as the most likely matching intention for this user.

The second row demonstrates the keyword “Java”, entered by a female user who is an engineer with an interest in sports, also located in India. The system selects three meshes—profession, gender, and location—based on their support values, with costs of 0.63, 0.6, and 0.7, respectively. After filtering, the user's intentions are reduced to categories like Research and Technology. Since Technology appears most frequently, the system returns “Technology” as the matching intention for the keyword “Java.”

The third row processes the keyword “Bond”, entered by a male user who is an engineer with an interest in movies, and is located in India. The system identifies location as the only mesh that meets the threshold, with a support value of 0.76. After filtering through this parameter, the possible intentions are narrowed down to categories like Movie and Legal. Based on the frequency of past searches, “Movie” is selected as the most likely matching intention for the keyword “Bond.”

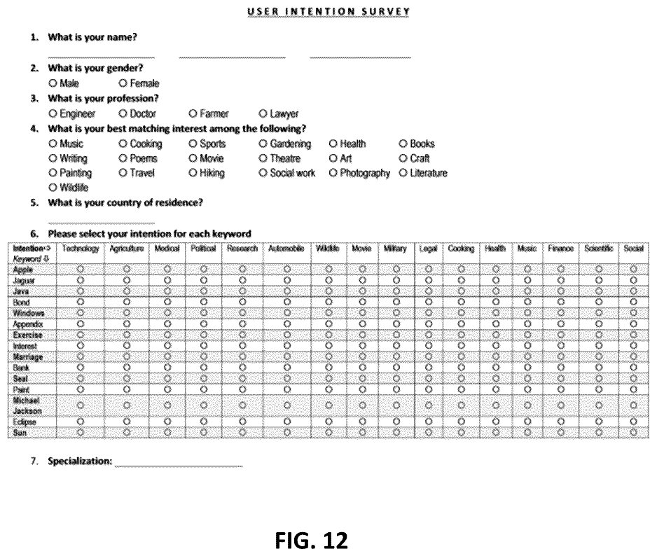

FIG. 12 is an illustration of a user intention survey, in accordance with some embodiments. The user intention survey is designed to gather user profile information and desired intentions of a user for specific keywords in a search context. This survey is structured as a paper-and-pencil-based questionnaire, aimed at collecting data from a large sample of users regarding their search preferences and intentions when encountering ambiguous keywords. The survey is a tool used to inform systems like the FM5 algorithm by providing real-world data on how users interpret various search queries based on their personal attributes.

The first section of the survey collects general user profile information, such as the respondent's name, gender, profession, interests, and country of residence. The multiple-choice format allows users to indicate their profession (e.g., Engineer, Doctor, Farmer, Lawyer) and interests (e.g., Music, Cooking, Sports, Books, Photography, etc.), which helps establish a detailed user profile. This information will be crucial in helping the system contextualize ambiguous keywords based on user attributes, ensuring personalized search results.

The second section focuses on the intended meanings of ambiguous keywords. The table lists several ambiguous keywords, such as Apple, Jaguar, Java, Bond, and Windows, in the leftmost column. The top row lists various intention categories, such as Technology, Agriculture, Medical, Political, Automobile, Wildlife, Movie, Legal, and more. Respondents are asked to select the intention they associate with each keyword by marking the appropriate box under the relevant category. For example, for the keyword “Apple,” a user might select Technology if they are referring to the company, or Agriculture if they are thinking of the fruit.

The survey captures how different users with varying profiles and interests interpret ambiguous keywords, and it helps build a more accurate intention prediction system by providing data on how different segments of users map specific keywords to categories. The intention grid allows users to express how they typically interpret each keyword across multiple contexts.

Lastly, the Specialization section provides additional space for users to specify further expertise or interests that might affect how they interpret certain keywords. This additional information allows the system to further fine-tune its understanding of user intentions based on unique or specialized user data. The data gathered through this survey serves as input to refine and enhance search algorithms, making them more attuned to individual preferences and interpretations of ambiguous search queries.

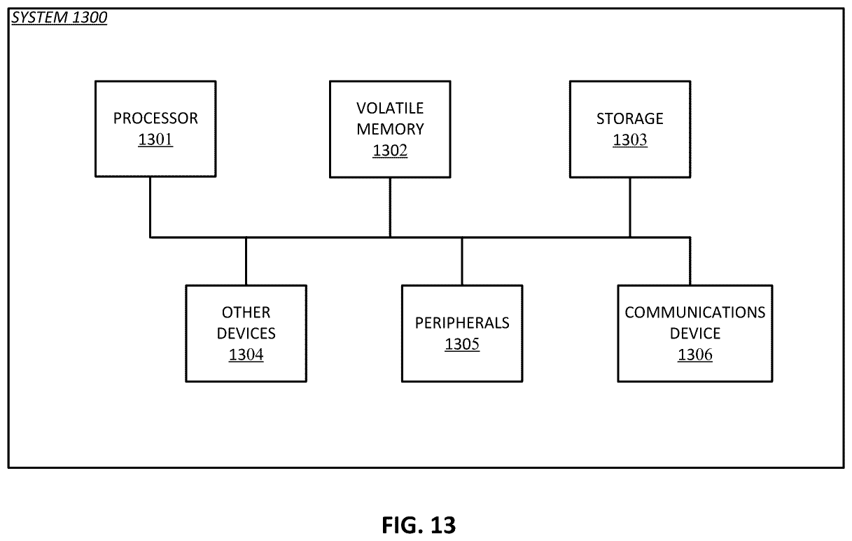

FIG. 13 is a diagram illustrating an exemplary computer that may perform processing in some embodiments. Exemplary computer 1300 may perform operations consistent with some embodiments. The architecture of computer 1300 is exemplary. Computers can be implemented in a variety of other ways. A wide variety of computers can be used in accordance with the embodiments herein.

Processor 1301 may perform computing functions such as running computer programs. The volatile memory 1302 may provide temporary storage of data for the processor 1301. RAM is one kind of volatile memory. Volatile memory typically requires power to maintain its stored information. Storage 1303 provides computer storage for data, instructions, and/or arbitrary information. Non-volatile memory, which can preserve data even when not powered and including disks and flash memory, is an example of storage. Storage 1303 may be organized as a file system, database, or in other ways. Data, instructions, and information may be loaded from storage 1303 into volatile memory 1302 for processing by the processor 1301.

The computer 1300 may include peripherals 1305. Peripherals 1305 may include input peripherals such as a keyboard, mouse, trackball, video camera, microphone, and other input devices. Peripherals 1305 may also include output devices such as a display. Peripherals 1305 may include removable media devices such as CD-R and DVD-R recorders/players. Communications device 1306 may connect the computer 100 to an external medium. For example, communications device 1306 may take the form of a network adapter that provides communications to a network. A computer 1300 may also include a variety of other devices 1304. The various components of the computer 1300 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure is, accordingly, to be regarded in an illustrative sense rather than a restrictive sense.

1. A method for identifying user intention for ambiguous search keywords in a search engine, comprising:
receiving a query prefix from a user, wherein the query prefix is an initial fragment of a search string input by the user in a search box of the search engine;
creating a user profile for the user, the user profile comprising a plurality of parameters;
applying a Funnel Mesh 5 (FM5) algorithm to identify possible user intentions for the query prefix, wherein the FM5 algorithm comprises:
mapping the parameters of the user profile to a plurality of meshes;
assigning weights to each of the meshes;
selecting a subset of meshes based on the assigned weights, the subset representing the user profile parameters with the highest assigned weights for disambiguating the search intention; and
utilizing the selected subset of meshes to identify a set of possible user intentions associated with the query prefix;
selecting a user intention from the set of possible user intentions with a highest support value as a most probable user intention for the query prefix;
dynamically updating the assigned weights and support values based on real-time user interactions and search outcomes to refine the disambiguation model;
expanding the query prefix into a complete search string based on the selected user intention; and
providing the complete search string to the search engine for generating a list of search results that are contextually relevant to the selected user intention.

2. The method of claim 1, wherein the parameters of the user profile are selected from the group consisting of: profession, interests, gender, location, and past searches.

3. The method of claim 1, wherein assigning weights to each of the meshes is based on the relevance of the corresponding parameter to the user's current search context.

4. The method of claim 1, wherein selecting the user intention with the highest support value further comprises applying an association rule mining technique to compute the support value for each user intention in the set of possible user intentions.

5. The method of claim 4, wherein the association rule mining technique utilizes a support-confidence framework to identify strong correlations between the user profile parameters and the intended search outcomes.

6. The method of claim 1, wherein the complete search string is designed to disambiguate the original query prefix and retrieve search results that are relevant to the user's identified intention.

7. The method of claim 1, wherein the FM5 algorithm is configured to allow the user to select specific parameters to be applied during the disambiguation process.

8. The method of claim 1, wherein the user profile is dynamically updated based on new search behaviors and interactions of the user with the search engine.

9. The method of claim 1, wherein the weights assigned to the meshes are calculated using a predefined weighting function that considers historical search patterns associated with each parameter.

10. The method of claim 1, further comprising adjusting the assigned weights based on the time of day or date of the search, wherein time-sensitive user intentions are given higher priority.

11. The method of claim 1, wherein the complete search string includes context-specific keywords that are automatically selected based on the identified user intention.

12. The method of claim 1, wherein the selection of the user intention is further refined by applying a secondary filtering process that compares the identified user intention against a database of previously resolved ambiguous search queries.

13. A system comprising:
one or more processors; and
memory storing instructions that, when executed by the one or more processors, cause the system to perform operations comprising:
receiving a query prefix from a user, wherein the query prefix is an initial fragment of a search string input by the user in a search box of the search engine;
creating a user profile for the user, the user profile comprising a plurality of parameters;
applying a Funnel Mesh 5 (FM5) algorithm to identify possible user intentions for the query prefix, wherein the FM5 algorithm comprises:
mapping the parameters of the user profile to a plurality of meshes;
assigning weights to each of the meshes;
selecting a subset of meshes based on the assigned weights, the subset representing the user profile parameters with the highest assigned weights for disambiguating the search intention; and
utilizing the selected subset of meshes to identify a set of possible user intentions associated with the query prefix;
selecting a user intention from the set of possible user intentions with a highest support value as a most probable user intention for the query prefix;
expanding the query prefix into a complete search string based on the selected user intention; and
providing the complete search string to the search engine for generating a list of search results that are contextually relevant to the selected user intention.

14. The system of claim 13, wherein the query expansion is performed iteratively, refining the search string with each successive character input by the user until the full search string is composed.

15. The system of claim 13, wherein the search engine returns a ranked list of search results, with the ranking adjusted based on the identified user intention to prioritize more relevant results.

16. The system of claim 13, wherein the instructions cause the system to further perform an operation comprising logging the identified user intention and the corresponding search results for future use in refining the FM5 algorithm.

17. The system of claim 13, wherein the search engine provides real-time feedback to the user on the identified intention and allows the user to manually confirm or adjust the intention before finalizing the search string.

18. The system of claim 13, wherein the FM5 algorithm is adapted to process user profiles and search queries in different languages.

19. The system of claim 13, wherein the system employs machine learning techniques to continuously improve the accuracy of the FM5 algorithm in predicting user intentions based on ongoing user interactions and search outcomes.

20. A non-transitory computer-readable medium containing instructions comprising:
receiving a query prefix from a user, wherein the query prefix is an initial fragment of a search string input by the user in a search box of the search engine;
creating a user profile for the user, the user profile comprising a plurality of parameters;
applying a Funnel Mesh 5 (FM5) algorithm to identify possible user intentions for the query prefix, wherein the FM5 algorithm comprises:
mapping the parameters of the user profile to a plurality of meshes;
assigning weights to each of the meshes;
selecting a subset of meshes based on the assigned weights, the subset representing the user profile parameters with the highest assigned weights for disambiguating the search intention; and
utilizing the selected subset of meshes to identify a set of possible user intentions associated with the query prefix;
selecting a user intention from the set of possible user intentions with a highest support value as a most probable user intention for the query prefix;
dynamically updating the assigned weights and support values based on real-time user interactions and search outcomes to refine the disambiguation model;
expanding the query prefix into a complete search string based on the selected user intention; and
providing the complete search string to the search engine for generating a list of search results that are contextually relevant to the selected user intention.
